(19) United States
(12) Patent Application Publication
(10) Pub. No.: US 2026/0280148 A1
(43) Pub. Date: Sep. 17, 2026

(54) TRIANGULAR VIVALDI ANTENNA ARRAY AND ANTENNA SYSTEM

(71) Applicant: Telefonaktiebolaget LM Ericsson (publ), Stockholm (SE)

(72) Inventors: Christos KOLITSIDAS, Hässelby (SE); Darwin BLANCO, Hässelby (SE); Omar ORGEIRA ALVAREZ, Bonn (DE)

(21) Appl. No.: 19/168,841

(22) PCT Filed: Jun. 6, 2023
(86) PCT No.: PCT/EP2023/065031

§ 371 Date: Sep. 25, 2025

(30) Foreign Application Priority Data
Mar. 29, 2023 (GR) 20230100264

(51) Int. Cl. H01Q 21/06; H01Q 13/08

(52) U.S. Cl. CPC H01Q 21/067; H01Q 13/08

(57) ABSTRACT

Disclosed is an antenna array comprising a plurality of Vivaldi antennas having a respective feed slot and defining a triangular lattice, the antenna array having a feeding side and a radiation side opposite to the feeding side, wherein at least one of the feed slots is open at the feeding side. Also disclosed is an antenna system comprising the antenna array and a feeding unit. The feeding unit comprises a plurality of feeding elements arranged such that, when the feeding unit is arranged in a predefined pose relative to the antenna array, electromagnetic signals can be fed via the plurality of feeding elements into at least one of the plurality of Vivaldi antennas of the antenna array to cause the at least one Vivaldi antenna to emit radio waves.

### TECHNICAL FIELD

The present disclosure generally relates to an antenna array comprising a plurality of Vivaldi antennas arranged in a triangular lattice, and to an antenna system comprising the antenna array.

### BACKGROUND

Highly-directional base stations may be required in order to cope with the ever-increasing amount of data transfer rates for mobile communications. In this context, antenna arrays capable of beam-forming have been introduced. For example, phased antenna arrays may be used, comprising a plurality of antenna elements that lie within a same plane. Each antenna element of the antenna array may be controlled individually by providing it with an antenna signal having an element-specific phase and amplitude.

Typical antenna arrays use antenna elements arranged in a rectangular or square pattern, with a given periodical spacing “a” along an x-direction and a given periodical spacing “b” along a y-direction of the plane, as indicated in FIG. 1a. Each of the antenna elements may be capable of emitting first electromagnetic waves having a first polarization and/or second electromagnetic waves having a different, second polarization, or a superposition of the first and second waves. In the example of FIG. 1b, the first polarization direction extends in the x-direction and the second polarization direction extends in the y-direction. In this exemplary so-called “egg-crate” lattice, each of the antenna elements is associated with exactly one polarization direction, but the overall antenna array can be referred to as being dual-polarized or enabling dual-polarization. Dual-polarized arrays are often based on a square lattice, for which an optimal aperture sampling of λ_{high}/2 allows scanning without grating lobes up to a high frequency f_{high}. Grating lobes are undesired beams in the radiation pattern of identical or very similar magnitude as the main beam, but they point towards an unwanted direction.

One type of antenna element usable in an antenna array is a so-called Vivaldi antenna, also referred to as tapered-slot antenna. Vivaldi antennas may be used for a wide frequency range of feeding signals.

Generally speaking, the higher the number of antenna elements, the higher the cost of the antenna array. This cost factor becomes particularly relevant if each antenna element is fed with a dedicated feeding structure or network comprising amplifiers, phase shifters or the like. Furthermore, a size of the antenna array may need to be minimized. It may be desired to configure the antenna array such that it is physically stable, for example to prolong its lifetime and ease installation. Another desirable measure for easing installation may lie in providing an easy physical coupling between the antenna array and a feeding unit. A coupling degree of feeding signals into the antenna elements of the antenna array may need to be maximized.

### SUMMARY

There is a need for an antenna array and an antenna system that solves one or more of the above and/or other problems.

According to a first aspect, an antenna array is provided.

The antenna array comprises a plurality of vivaldi antennas having a respective feed slot.

Vivaldi antennas may be used for a wide frequency range of feeding signals.

Each of the Vivaldi antennas may have a respective (e.g., associated) feed slot. Each Vivaldi antenna may be referred to as an antenna element. The plurality of Vivaldi antennas may comprise at least two or at least three Vivaldi antennas. A Vivaldi antenna may also be referred to as a tapered-slot antenna. A Vivaldi antenna as understood herein may comprise two antenna portions shaped such that a distance between the antenna portions increases (e.g., non-linearly, exponentially or according to a polynomial function) along a radiation direction of the Vivaldi antenna. The antenna portions may be configured to be electrically conductive. For example, the antenna portions may be formed of a metal or metal alloy. The space between the two opposing antenna portions may generally be referred to as slot or tapered slot. The tapered slot may be bounded by two opposing (e.g., single-curved) surfaces, each being formed by a different one of the antenna portions. Feeding signals may be coupled into a feed slot of the Vivaldi antenna that transitions into the tapered slot thereof. The feed slot may correspond to a section of the space between the two antenna portions (e.g., the opposing surfaces thereof) having a constant width (e.g., a constant distance between the two opposing antenna portions). An electromagnetic feeding signal coupled into the feed slot may travel through the feed slot into the tapered slot, and along the widening tapered slot, until it is emitted as a radio wave from the Vivaldi antenna.

The plurality of vivaldi antennas defines a triangular lattice.

By arranging the plurality of Vivaldi antennas of the antenna array such that they define a triangular lattice, a number of Vivaldi antennas may be reduced compared with other types of lattices such as a square lattice while maintaining performance of the antenna array.

The Vivaldi antennas of the antenna array may be arranged in a triangular lattice. The antenna array may also be referred to as a (e.g., equilateral) triangular Vivaldi antenna array. A triangular antenna array as understood herein may not form an overall triangle. A triangular antenna array as understood herein may consist of antenna elements aligned relative to one another in a triangular lattice. The Vivaldi antennas may be arranged within a same (e.g., x/y-) plane. The Vivaldi antennas may define the triangular lattice by having (e.g., common) tips (e.g., of the antenna portions of the Vivaldi antennas) that are arranged in the triangular lattice (e.g., in the form of a grid). The tips may be distal tips (e.g., along the radiation and/or z-direction of the Vivaldi antennas) of the Vivaldi antennas. The tips may be the outermost (e.g., last) tips relative to the radiation direction of the Vivaldi antennas. Each of the (e.g., common) tips may be associated with one, two, three or four (e.g., antenna portions of different ones) of the Vivaldi antennas. One may say that each of the (e.g., distal tips of the antenna portions of the) Vivaldi antennas lies on an intersection point of (e.g., at least two or at least three) lines of the triangular lattice. The triangular lattice may be represented by three sets of lines (e.g., lying in the x/y-plane), wherein lines within each set are parallel and lines of different sets are non-parallel. Each of the (e.g., tips of the) Vivaldi antennas may lie on an intersection point of three lines, each of the three lines being of a different one of the three sets of lines.

The antenna array has a feeding side and a radiation side opposite to the feeding side.

By arranging the feeding side opposite to the radiation side, a feed unit may be arranged adjacent to the antenna array without interfering with radio waves emitted by the antenna array.

The feeding side may correspond to an outer (e.g. bottom) surface of the antenna array. The feeding side may be configured to be fed with electromagnetic signals.

The radiation side may be configured to emit radio waves based on feeding signals provided to the antenna array (e.g., based on the fed electromagnetic signals). The distal tips and/or the outermost portions of the Vivaldi antennas may extend along and/or into a radiation (e.g., emission) direction of the radio waves.

At least one (e.g., two, three or all) of the feed slots is open at the feeding side.

By using feed slots that open at the feeding side, feed signals may be fed into the feed slots from a position adjacent to the feeding side. In other words, the antenna array may be fed with feeding signals via one or more feeding elements that are not integrated into the (e.g., Vivaldi antennas of the) antenna array.

The at least one feed slot and/or each of the feed slots may be configured to receive an electromagnetic signal (e.g., to excite the respective Vivaldi antenna based on the electromagnetic signal). The at least one feed slot and/or each of the feed slots may be configured such that, when feeding the respective Vivaldi antenna, electromagnetic waves travel from the feeding side to the radiation side through the feed slot. The at least one feed slot and/or each of the feed slots may be entirely filled with the same material (e.g., air).

The at least one feed slot and/or each of the feed slots may extend through the antenna array from the feeding side to the radiation side. The at least one feed slot and/or each of the feed slots may be configured as a through-hole. The at least one feed slot and/or each of the feed slots may be open in a direction of radiation of the respective Vivaldi antenna and open in a direction opposite to the direction of radiation of the respective Vivaldi antenna. The Vivaldi antennas may be arranged on a base and the feed slots may extend throughout the base. The at least one feed slot and/or each of the feed slots may be accessible from the feeding side. The at least one feed slot and/or each of the feed slots may be accessible from the radiation side. The at least one feed slot and/or each of the feed slots may be bounded exclusively by surface portions (e.g., of antenna portions of the respective Vivaldi antenna) that extend parallel to a same line. The at least one feed slot and/or each of the feed slots may correspond to a parallel projection of an outline of the respective feed slot, the parallel projection extending through the base and/or the (e.g., bulk of the) antenna array.

The antenna array may be configured and/or manufactured as a single piece. The antenna array may be carved out of a single block of material. Alternatively, the antenna array may be additively manufactured (e.g., by selective layer-wise solidification of a metal powder). The antenna array may consist of a single material composition (e.g., a metal or a metal alloy). At least one (e.g., all) of the Vivaldi antennas may be configured as a self-supporting structure (e.g., without a supporting dielectric base material). A single-piece antenna array may be very rigid compared with a multi-piece antenna array, and may reduce manufacturing costs.

At least one of the Vivaldi antennas may comprise two opposing antenna portions separated by a tapered slot (e.g., transitioning and/or merging into the feed slot of the respective Vivaldi antenna). Antenna portions of multiple (e.g., two, three or four) adjacent (e.g., neighboring) Vivaldi antennas of the antenna array may join together in a common distal tip. The distal tips of the (e.g., antenna portions of the) Vivaldi antennas of the antenna array may form and/or be arranged in a (e.g., equilateral) triangular grid.

The antenna array may be configured to be void-free. The antenna array may be configured to be overhang-free. The antenna array may be configured to be free of internal cavities and/or voids. Such configurations may reduce manufacturing costs of the antenna array.

The at least one feed slot and/or each of the feed slots may be configured such that is free from a cutoff frequency for a feed signal. The at least one feed slot and/or each of the feed slots may be configured to behave more similar to a parallel plate waveguide than to a rectangular waveguide. The at least one feed slot and/or each of the feed slots may have a non-rectangular outline (e.g., when looking from the feeding side to the radiation side), for example in the x/y-plane and/or the feeding side of the antenna array. The at least one feed slot and/or each of the feed slots may be configured such that it does not act as a waveguide, at least at a set or a range of predefined feeding signal frequencies. A cross-sectional area of the at least one feed slot and/or each of the feed slots may be constant from the feeding side toward the radiation side.

The at least one feed slot and/or each of the feed slots may have an outline comprising a rectangular inner portion and at least one outer portion adjacent to the inner portion, the at least one outer portion being wider, longer and/or rounder than the inner portion. The at least one outer portion may comprise two (e.g., rectangular, oval or rounded) elongated sections, each extending and/or being aligned in a different direction. The two elongated sections may each extend non-parallel to the inner portion. The two elongated sections may each extend slant relative to the inner portion. The two elongated sections may be arranged symmetrical relative to one another. The at least one feed slot and/or each of the feed slots may be symmetrical, for example mirror-symmetric. The at least one feed slot and/or each of the feed slots may have a H-shaped, dumbbell-shaped and/or dog-bone-shaped outline.

The at least one feed slot and/or each of the feed slots may be bounded by at least two opposing parallel planar surface portions (e.g., of the two antenna portions of the respective Vivaldi antenna). Two of the opposing parallel planar surface potions may define two opposite sides of the rectangular inner portion of the outline of the respective feed slot. The at least one feed slot and/or each of the feed slots may comprise a feed volume between (e.g., the) two of the opposing parallel planar surface portions. The at least one feed slot and/or each of the feed slots may comprise at least one resonance cavity adjacent to the feed volume. An outline of the at least one resonance cavity may correspond to the at least one outer portion. For example, the outline of the at least one resonance cavity is circular, with the circle optionally having a diameter larger than a narrow-most portion of the inner portion.

Such configurations of the feed slot(s) may improve coupling efficiency of a feeding signal into the respective Vivaldi antenna, antenna gain of the respective Vivaldi antenna and/or frequency behavior of the respective Vivaldi antenna.

The at least one resonance cavity may transition, at the radiation side, into a widening portion. The widening portion may be referred to as a first tapered upper surface.

The feed volume may transition, at the radiation side, into a radiating portion of the respective Vivaldi antenna. The radiating portion may correspond to the tapered slot (e.g., the tapered part of the tapered-slot antenna). The radiating portion may widen differently (e.g., slower along the radiation direction and/or z-direction) than the widening portion.

Such configurations may improve rigidity of the antenna array while ensuring a high coupling efficiency of a feeding signal into the respective Vivaldi antenna, a high antenna gain of the respective Vivaldi antenna and/or a desired frequency behavior of the respective Vivaldi antenna.

The antenna array may be configured to be fed with a stripline or a microstrip (e.g., when the stripline or microstrip is arranged adjacent to the feed slot of one of the Vivaldi antennas on the feeding side). This type of feeding may reduce manufacturing and/or assembly costs, and may enable use of planar feeding structures.

The antenna array may be configured as a dual-polarized and/or orthogonally-polarized antenna array. The feed slots of a first subset of the Vivaldi antennas may be aligned into a first direction. The feed slots of a second subset of the Vivaldi antennas may be aligned into a second direction. The first direction may differ from the second direction, for example by a predefined angle such as 45°, 60° or 90°.

The antenna array may be configured for emitting radio waves within at least one predefined frequency band, for example a frequency band between 100 MHz-500 GHz, 1 GHz-250 GHz or 10 GHz-200 GHz. The at least one predefined frequency band may comprise low-band (e.g., 600-900 MHz), mid-band (e.g., 1.7-4.7 GHz) and/or high-band (e.g., 24-54 GHz) millimeter-waves according to the 5^{th} Generation (5G) communication standard, also known as New Radio (NR). Other frequency bands are also possible. The dimensions of the antenna array may be scaled depending on the at least one predefined frequency band.

According to a second aspect, an antenna system is provided. The antenna system comprises the antenna array according to the first aspect.

The antenna system further comprises a feeding unit. The feeding unit comprises a plurality of feeding elements. The feeding elements are arranged such that, when the feeding unit is arranged in a predefined (e.g., fixed) pose relative to the antenna array, electromagnetic signals can be fed (e.g., with a feeding efficiency above a predefined threshold, with a signal loss below a predefined threshold and/or to provide a predefined antenna gain) via the plurality of feeding elements (e.g., contactless) into at least one (e.g., at least two, at least three, or each) of the plurality of Vivaldi antennas of the antenna array to cause the at least one Vivaldi antenna to emit radio waves.

The plurality of feeding elements may be arranged in a same plane. The plurality of feeding elements may be arranged on a same (e.g., planar) substrate.

The antenna array may have a first outer surface on the feeding side. The at least one feed slot and/or each of the feed slots may be open (e.g., begin) at the first outer surface. The feeding unit may have a second outer surface configured to be aligned in parallel with the first outer surface when the feeding unit is arranged in the predefined pose relative to the antenna array. The second surface may be parallel to the plane in which the plurality of feeding elements are arranged.

The system may be configured such that the first outer surface and the second outer surface are in contact with one another when the feeding unit is arranged in the predefined pose relative to the antenna array. Alternatively, the system may be configured such that the first outer surface and the second outer surface are spaced apart from one another when the feeding unit is arranged in the predefined pose relative to the antenna array. In this variant, a space between the first outer surface and the second outer surface may be filled at least partially with a filler material (e.g., a glue, an electrically conductive paste or a spacer foil).

The antenna system may comprise one or more alignment elements configured to align the feeding unit in the predefined pose relative to the antenna array. The alignment elements may comprise at least one of (i) a pin attached to the antenna array and/or the feeding unit; and (ii) a recess for a pin attached to the antenna array and/or the feeding unit. The one or more alignment elements may be configured to attach the feeding unit in the predefined pose to the antenna array or vice versa. The one or more alignment elements may be configured as heat conductive elements (e.g., to transfer thermal energy between the antenna array and the feeding unit), which may allow using the antenna array as a cooling body for the feeding unit or vice versa. For example, the one or more alignment elements are made of metal or a metal alloy.

Each of two or more of the plurality of feeding elements may be associated with a different one of the feed slots of the Vivaldi antennas.

At least one (e.g., each of the two or more) of the plurality of feeding elements may be configured to, when the feeding unit is arranged in the predefined pose relative to the antenna array, extend across (e.g., the rectangular inner portion and/or the feed volume of) the feed slot of the associated Vivaldi antenna. At least one (e.g., each of the two or more) of the plurality of feeding elements may be configured to, when the feeding unit is arranged in the predefined pose relative to the antenna array, extend perpendicular to the feed slot and/or across a most narrow portion of the feed slot of the associated Vivaldi antenna.

At least one (e.g., two or more, or each) of the plurality of feeding elements may comprise a stripline and/or a microstrip. For example, at least one (e.g., two or more, or each) of the plurality of feeding elements is a stripline. The stripline may be configured as a suspended stripline, for example an asymmetric suspended stripline.

A first subset of the plurality of feeding elements may be electrically coupled together into a first group. A second subset of the plurality of feeding elements may be electrically coupled together into a second group. The first subset may differ from the second subset. The first subset of the plurality of feeding elements may be associated with the first subset of the Vivaldi antennas. The second subset of the plurality of feeding elements may be associated with the second subset of Vivaldi antennas. The first subset of feeding elements may be associated with a first polarization direction and the second subset of feeding elements may be associated with a different (e.g., orthogonal) second polarization direction.

These configurations of the system may ease the assembly of the system, ensure that the feeding elements are placed in desired locations relative to the feed slots, and reduce manufacturing and/or assembly costs.

According to a third aspect, a feeding unit is provided. The feeding unit may comprise some or all features of the feeding unit described for the system according to the second aspect. The feeding unit according to the third aspect comprises a plurality of feeding elements. The feeding elements are arranged such that, when the feeding unit is arranged in a predefined (e.g., fixed) pose relative to a Vivaldi antenna array (e.g., the antenna array according to the first aspect), electromagnetic signals can be fed via the plurality of feeding elements (e.g., contactless) into at least two of the Vivaldi antennas of the antenna array to cause the at least two Vivaldi antennas to emit radio waves, wherein each of the plurality of feeding elements is configured to, when the feeding unit is arranged in the predefined pose relative to the Vivaldi antenna array, extend across a feed slot of an associated Vivaldi antenna of the Vivaldi antenna array.

### BRIEF DESCRIPTION OF THE DRAWINGS

These and other aspects will now be further described, by way of example only, with reference to the accompanying figures, wherein like reference numerals may refer to like parts, and in which:

FIG. 1a shows antenna elements arranged in a rectangular grid;

FIG. 1b shows orthogonal polarizations of electromagnetic waves emitted by the antenna elements of FIG. 1a;

FIG. 2a shows antenna elements arranged in a triangular grid;

FIG. 2b shows orthogonal polarizations of electromagnetic waves emitted by the antenna elements of FIG. 2a;

FIG. 3a shows a first perspective view of two Vivaldi antennas according to the present disclosure;

FIG. 3b shows a second perspective view of the two Vivaldi antennas of FIG. 3a;

FIG. 4a shows a first perspective view of a Vivaldi antenna array in accordance with the present disclosure;

FIG. 4b shows a second perspective view of a Vivaldi antenna array in accordance with the present disclosure;

FIG. 5a shows a perspective view and an enlarged view of a first configuration of two Vivaldi antennas according to the present disclosure;

FIG. 5b shows a perspective view and an enlarged view of a second configuration of two Vivaldi antennas according to the present disclosure;

FIG. 5c shows a first perspective view and an enlarged view of a third configuration of two Vivaldi antennas according to the present disclosure;

FIG. 6a shows a second perspective view of the third configuration of the two Vivaldi antennas of FIG. 5c;

FIG. 6a shows a third perspective view of the third configuration of the two Vivaldi antennas of FIG. 5c;

FIG. 7 shows an antenna array according to the present disclosure;

FIG. 8 shows a schematic illustration of an asymmetrical suspended stripline according to the present disclosure;

FIG. 9 shows a first perspective view of a feeding unit according to the present disclosure;

FIG. 10 shows a second perspective view of the feeding unit of FIG. 9; and

FIG. 11 shows a system according to the present disclosure.

### DETAILED DESCRIPTION

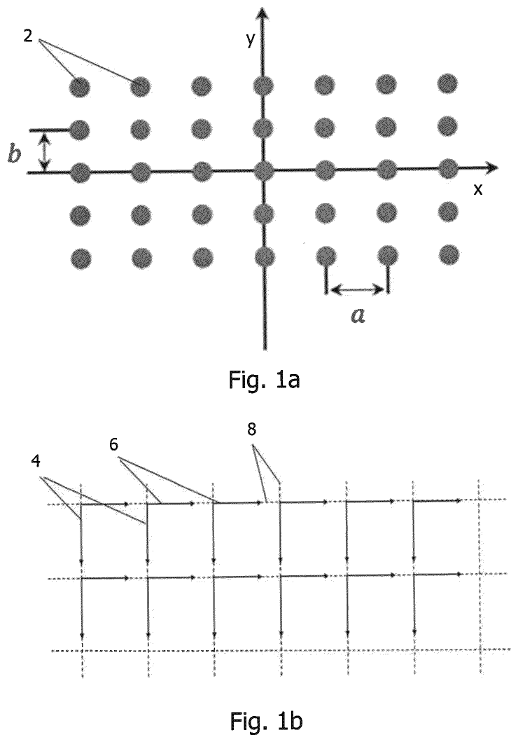

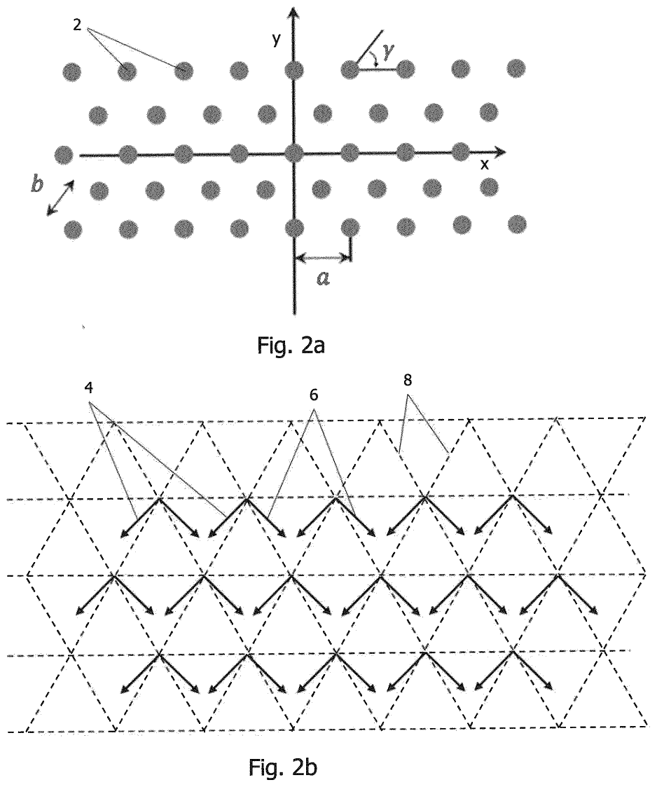

A triangular equilateral lattice, also known as a hexagonal lattice, may give up to a 15.5% reduction of required antennas compared to an optimally sampled square lattice (e.g., the lattice shown in FIG. 1a with a=b). FIG. 2a shows antenna elements 2 arranged in such a triangular grid with a=b and y=60°. The array lattice may control the appearance of grating lobes. In the case of a rectangular lattice, as stated before, the maximum element spacing is λ_{high}/2 in both directions, horizontal and vertical, with λ_{high} corresponding to a minimum wavelength associated with the antenna elements 2 (e.g., corresponding to a maximum operational frequency of the antenna elements 2). For example, in case of a maximum operational frequency of 15 GHz, λ_{high} may be 20 mm. On the other hand, the maximum element spacing for a grating lobe free situation of an equilateral triangular lattice is λ_{high}/\sqrt{3}. The square and equilateral triangular lattices for the maximum element spacing without grating lobes are represented in FIGS. 1a and 2a, where for the rectangular lattice a=b=λ_{high}/2, and for the equilateral triangular lattice a=b=λ_{high}/\sqrt{3} with grid angle y=60°. By rearranging the antenna elements of an antenna array such that they are arranged in a triangular grid, the number of required antennas may be reduced while ensuring sampling of the same aperture.

FIG. 2b illustrates orthogonal polarization directions of electromagnetic waves emitted by the antenna elements 2 of the antenna array illustrated in FIG. 2a. It can be seen that the polarization directions 4, 6 are not aligned with from the grid lines 8 connecting the antenna elements 2, which is not the case for a rectangular grid (see FIG. 1b). The present disclosure provides for triangular antenna array that may be configured as an orthogonally-polarized and/or dual-polarized antenna array. That is, the array disclosed herein may be configured to emit electromagnetic waves having polarization directions 4, 6 as indicated in FIG. 2b. These polarization directions 4, 6 deviate from the grid lines 8, but the different polarization directions 4, 6 deviate from their closest grid lines 8 to a similar angular amount. In the illustrated example of FIG. 2b, each polarization direction deviates from an angularly closest gridline by 15°.

Orthogonally dual-polarized Vivaldi antenna arrays may require Vivaldi antennas having tapered slots aligned relative to one another at 90° angles (e.g., to keep reasonable cross-talk level between polarizations). But at the same time, the antennas may need to be aligned at 60° angles relative to one another (e.g., to ensure continuous transverse current that is required for a wideband performance).

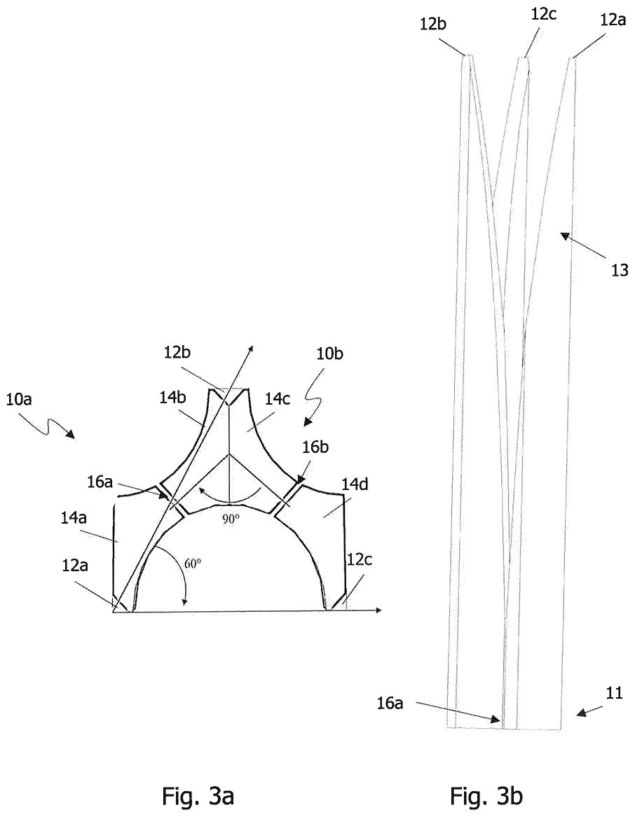

FIGS. 3a-3b show a perspective views of two Vivaldi antennas 10 according to the present disclosure, designated with reference numerals 10a, 10b. The antenna array disclosed herein may comprise these two Vivaldi antennas 10a, 10b at least once. As can be seen, the distal tips 12, indicated with reference numerals 12a-12c, of the respective antenna portions 14, indicated with reference numerals 14a, 14b and 14c, 14d, of the Vivaldi antennas 10a, 10b are arranged in an (e.g., equilateral) triangular grid. Each of the Vivaldi antennas 10a, 10b comprises a respective feed slot 16, indicated with reference signs 16a, 16b. The feed slots of the Vivaldi antennas 10a, 10b are oriented into different spatial directions. In the example shown, the feed slots 16a, 16b are orthogonal to one another which means the Vivaldi antennas 10a, 10b form a dual-polarized, in particular orthogonally polarized antenna array having a feeding side 11 and a radiation side 13. The feed slots 16 extend from the feeding side 11 to the radiation side. One may say that the feed slots 16 are formed as through-holes.

According to the present disclosure, branches (e.g., the antenna portions 14) of the Vivaldi antennas 10 may start at 90° with respect to each other to assure the orthogonality between polarizations, and they may bend and/or slant until, at the distal end (e.g., the distal ends 12 or the distal end of the tapered radiation slot), they form a 60° angle. This bending may not alter the polarization of the electric fields since the fields will always choose the shortest path between two conductors. Such Vivaldi antennas may be versatile regarding manufacturing techniques since they are simple to manufacture using Computerized Numerical Control (CNC) milling, Electrical Discharge Machining (EDM) and/or three-dimensional (3D) printing. Conventional manufacturing such as CNC milling might lead to a short lead time and this Vivaldi antenna geometry configuration may not present any feature that is especially tricky for milling.

In one example, each flare tapers from a tapered radiation slot opening of width 12.13 mm (0.61 λ_{high}) at the radiator tip, down to a slot width of 0.44 mm (0.022 λ_{high}) at the base of the tapered radiation slot opening where then a small constant width section follows, also referred to as feed slot herein. Unlike a typical square lattice, these slant-right and slant-left radiators may not decompose into linear sub-arrays.

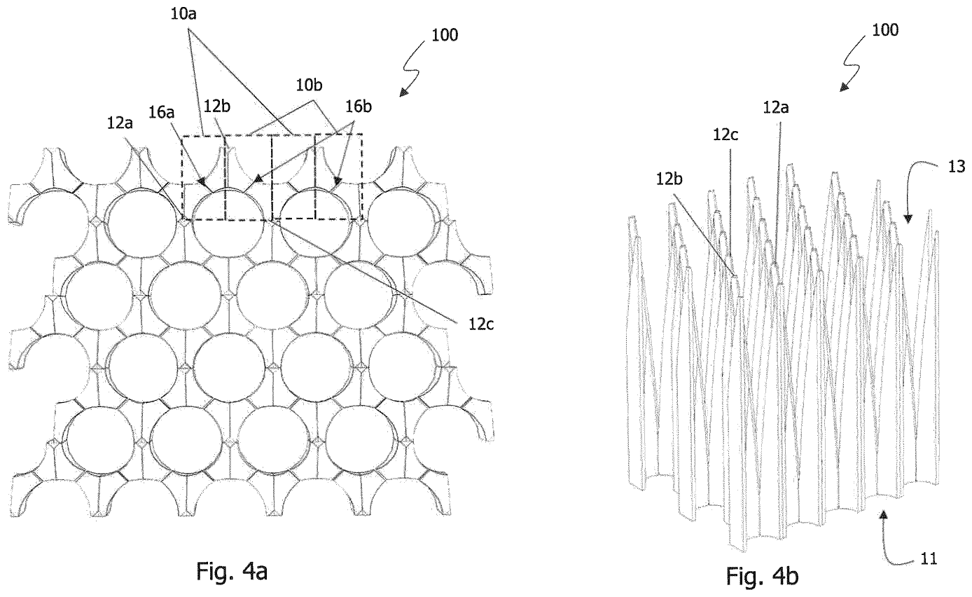

FIG. 4a-4b show perspective views of a Vivaldi antenna array 100 in accordance with the present disclosure. The Vivaldi antenna array 100 comprises multiple sets of the Vivaldi antennas 10 (e.g., 10a and 10b). The distal tips 12 (e.g., 12a-12c) of the antenna portions 14 (e.g., 14a-14d) are arranged in a triangular lattice, whereas the feed slots 16 (e.g., 16a, 16b) of the Vivaldi antennas 10 are aligned into a first direction or an orthogonal second direction. Thus, the antenna array 100 is configured as an orthogonally polarized triangular Vivaldi antenna array. The opposing surfaces of the antenna portions 14e, 14f associated with a same Vivaldi antenna 10c merge into parallel surface portions at the feeding side 11, which bound the feed slot of the same Vivaldi antenna 10c.

It may be desired to give the antenna array 100 structural rigidity and ensure continuity to the antenna array 100. Structural rigidity and continuity of the antenna array 100 may be achieved by arranging the Vivaldi antennas on a base (e.g., during manufacturing). It may be desirable to manufacture the antenna array 100 as a single, rigid component instead of separately attaching different antenna portions 14 to a base plate in an accurately aligned manner.

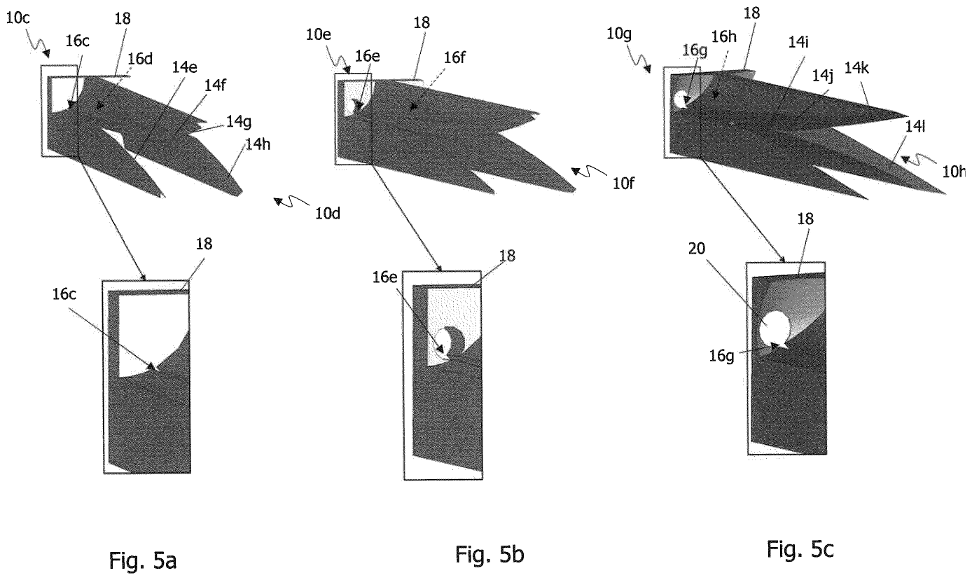

FIG. 5a shows a perspective view and an enlarged view of a first configuration of two Vivaldi antennas 10c, 10d according to the present disclosure. As apparent from a comparison with FIGS. 3a and 3b, the antenna portions 14e-14h in this case are supported by a base 18 of the single-piece antenna array 100. The rectangularly shaped feed slots 16c, 16d extend throughout the base 18. The base 18 may have a thickness of several millimeters (e.g., 3 mm) and may be permanently fixed to the Vivaldi antennas 10c, 10d. The antenna array 100 comprising the base 18 may be manufactured from a single block of material.

In the example of FIG. 5a, the base 18 may transform the feed slot 16 in to a small waveguide (e.g., of dimensions 2.17×0.44 mm). This may result in a cutoff frequency of 70 GHz. In order to minimize this drawback, an outline of the respective feed slots 16 may be adapted.

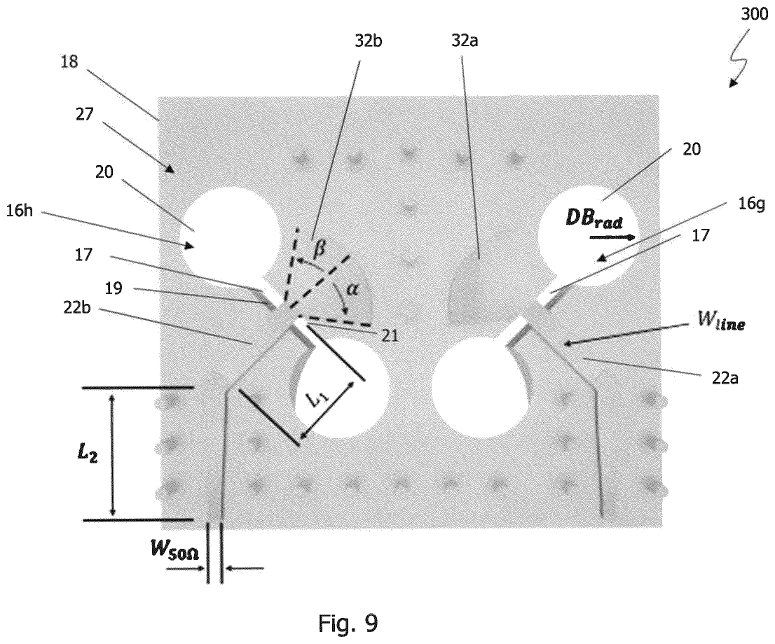

FIG. 5b shows a perspective view and an enlarged view of a second configuration of two Vivaldi antennas 10e, 10f according to the present disclosure. As can be seen, the feed slots 16e, 16f have a non-rectangular outline. The feed slots may be bounded by two opposing parallel planed surface portions 19, 21. The feed slots 16 comprise a feed volume 17 having a rectangular outline, and two adjacent cavities 20 having circular outlines. The surface portions 19, 21 and the feed volume 17 are not indicated in FIG. 5b for simplicity, but are indicated in FIG. 9, for example. This adjustment of the contour of the feed slots 16 results in an overall dogbone-shaped outline of each feed slot 16 extending linearly throughout the base 18. The peripheral circular portions of the dogbone-shaped feed slot act as cavities 20 and may have a diameter of λ_{high}/4. The cavities 20 may act as high impedance cavities and therefore, they may cut currents on the side walls of the feed slot 16. Thus, the waveguide boundary condition may be changed to a parallel plate waveguide (PPW), which may result in an absence of the cut off frequency (e.g., of 70 GHz). Due to spatial constraints, it may not be possible to size the peripheral circular portions sufficiently large to fulfil the aforementioned criterion. For example, it may only be possible to provide a diameter of λ_{high}/10.

The base 18 may be 50-500 μm thick, for example 0.1 mm. This may ensure that the feed slot 16 having the dogbone-shaped outline works as a slot and not as a waveguide. On the other hand, if one were to reduce the thickness of the base 18 everywhere, the base 18 may no longer provide the desired structural rigidity to the antenna array 100, and the antenna array 100 may even bend under its own weight resulting in misalignment of the Vivaldi antennas 10. To address these issues, the base 18 may be configured to be around 0.1 mm thick at the feed slot 16 (e.g., to enable sufficient coupling) and may be thicker distant from the feed slot (e.g., to enable sufficient structural rigidity).

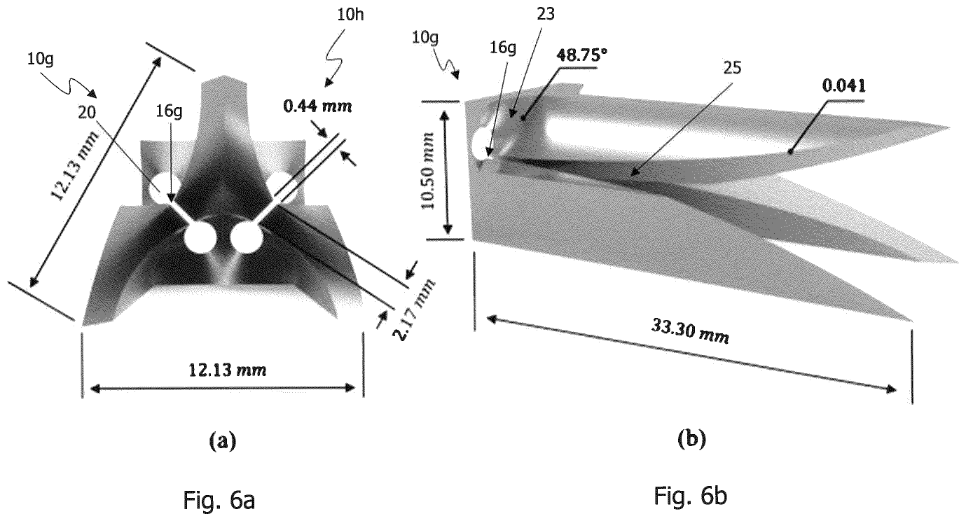

In one example, an outer, circular portion of the dogbone-shaped feed slot 16 may transition into a widening portion 23 at the radiation side 13 to form a funnel-like shape. The feed slot 16 may transition into a radiating portion 25 at the radiation side 13. FIG. 5c shows a first perspective view and an enlarged view of a third configuration of two Vivaldi antennas 10g, 10h according to the present disclosure. The same Vivaldi antennas 10g, 10h are depicted in FIGS. 6a and 6b. As can be seen, the circular resonance cavity 20 of the feed slot 16g that is open in both the upper and lower z-direction tapers at the upper side, also referred to as radiation side herein.

The taper angle of approximately 45-50° may be higher than the opening angle of the tapered slot 22 between the antenna portions 14i-14l. The feed slots 16 may have a width of 0.44 mm and a length of 2.17 mm. The spacing of the triangular grid, corresponding to a distance between adjacent distal tips 12 of the Vivaldi antennas 10, may be 12.13 mm. The upper surface merging into the circular cavity 20 of the feed slot 16 may have a taper angle of 48.75. A distance from an entry of the feed slot 16 to the distal tip 12 of the associated Vivaldi antenna 10 may be 33.30 mm. These dimensions, also indicated in FIG. 6a and FIG. 6b, are exemplary and non-limiting. Other dimensions may be chosen depending on the desired frequency behavior of the antenna array.

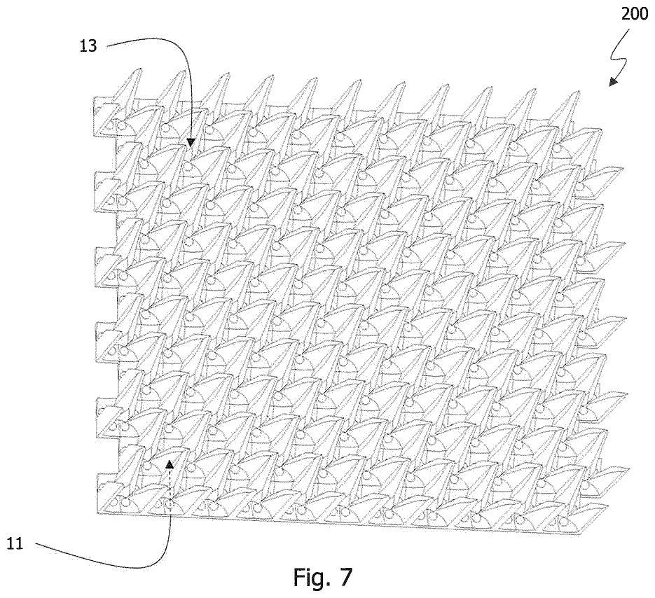

FIG. 7 shows an antenna array 200 according to the present disclosure. In this case, the antenna array 200 is configured as a dual-polarized, single-piece triangular Vivaldi antenna array comprising multiple sets of the Vivaldi antennas 10g, 10h. it can be seen that the single-piece antenna array comprises no internal voids and/or internal cavities and may thus be manufactured using traditional, material-removing manufacturing techniques such as sawing, milling, electrical wire discharge machining and drilling. The base 18 ensures a rigidity of the antenna array 200, whereas the specially shaped feed slots 16 ensure a high coupling efficiency and frequency range of the antenna array 200.

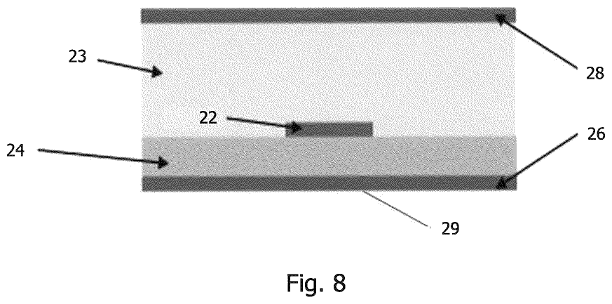

The antenna array 100, 200 may be fed using a feeding unit 300 comprising a plurality of striplines 22. These striplines 22 may be configured as asymmetric(al) suspended striplines. FIG. 8 shows a schematic illustration of an asymmetrical suspended stripline 22 according to the present disclosure. The stripline 22 may be arranged on a dielectric substrate 24 (e.g., FR-4 of 0.204 mm thickness or 0.102 mm thickness) covered with a ground plane 26 having an outer surface 29. In the opposite direction, the stripline 22 may be surrounded by a gas 23 (e.g., an air layer of 1 mm thickness) and covered with another ground plane 28. Generally speaking, the thinner the dielectric layer and the thicker the air layer, the better the coupling from feed signals into the feed slots 16 of the Vivaldi antennas 10.

FIG. 9 shows a first perspective view of a feeding unit 300 according to the present disclosure. The feeding unit 300 in this example comprises two striplines 22a, 22b arranged in the same plane, namely on the dielectric substrate 24. The ground plane 26 may comprise through-holes configured to surround different feed slots 16 of the antenna array 100, 200. Each of the striplines 22a, 22b may extend across an associated through-hole in the ground plane 26. The dielectric substrate 24 may also extend across these through-holes but is omitted in FIG. 9 for ease of reference. The ground plane 26 is also not shown, providing a clear view onto the bottom of the base 18 of the adjacent antenna array 200 including the dogbone-shaped feed slots 16g, 16h comprising the cavities 20. Each stripline 22 terminates in a respective (e.g., broadband matching) stub 32a, 32b and extends across a different one of the feed slots 16g, 16h when the feeding unit 300 is positioned in a predefined pose relative to the antenna array 200. The surface of the base 18 shown in FIG. 9 may correspond to a first outer surface 27 of the antenna array 200. The feeding unit 300 may be configured to be arranged such that the ground planes 26, 28, the microstrips 22 and/or the dielectric layer 24 are aligned parallel to the first outer surface 27 of the antenna array 200, in order to provide a coupling between the feeding unit 300 and the antenna array 200.

The width W_{50Ω} may be 0.32 mm, the width Wₗᵢₙₑ may be 0.55 mm, the length L1 may be 2.3 mm, the length L2 may be 2.9 mm, the radius of the stubs may be 1.9 mm, the angle α may be 58°, the angle β may be 40° and/or the radius of the circular portion of the dogbone slot may be 1.15 mm. Each stripline 22 may be configured to have a 50 Ω impedance (e.g., at least in a beginning of the stripline). Each stripline 22 may be be tapered from 0.32 mm width to 0.55 mm. The impedance of the stripline portion having 0.32 mm width may be around 35 Ω, whereas the impedance of the stripline portion having 0.55 mm width may be around 50 Ω. The tapering may follow a Klopfenstein-like curve. This kind of tapering may be optimal for a given tapering length (e.g., the reflection coefficient may be minimum over the passband). In other words, for a maximum allowed reflection coefficient the Klopfenstein tapering may give the shortest matching section. The Klopfestein taper may be derived from a stepped Chebyshev in which the number of sections increases to infinity. These dimensions are exemplary and may be adjusted depending on the desired supported frequency range of the feeding unit 300.

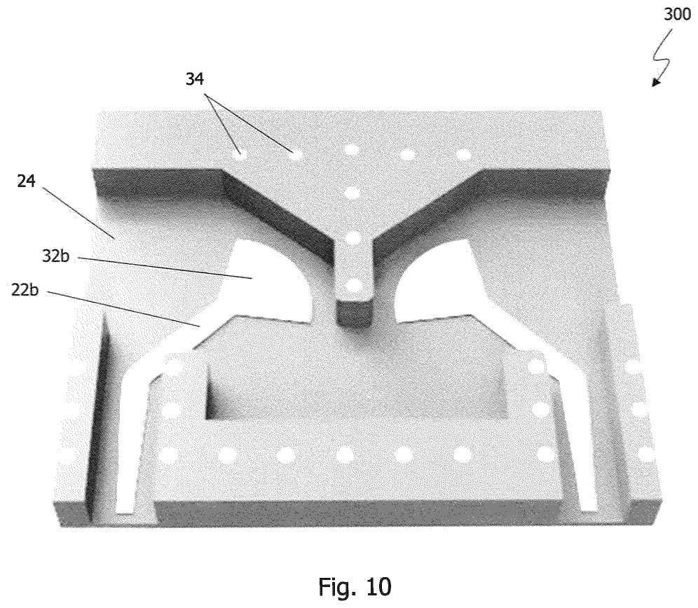

FIG. 10 shows a second perspective view of the feeding unit 300 of FIG. 9. In this case, the dielectric substrate 24 is also visualized. The feeding unit may be configured as a circuit board, e.g., a printed circuit board (PCB). It can be seen that the striplines 22a, 22b are surrounded by air 23. Vias 34 may be provided to reduce resonances within the feeding unit 300. The vias 34 may confine the signal under the striplines 22a, 22b and prevent leakage to the other ports, and resonances inside the PCB. It is to be understood that the feeding unit 300 maybe configured with multiple sets of the striplines 22a, 22b in case more than two Vivaldi antennas are to be fed. The feeding unit 300 may comprise a separate stripline 22 for each of the feed slots 16 of the antenna array 100, 200. The striplines 22 may be electrically connected in pairs, each pair being associated with a different polarization.

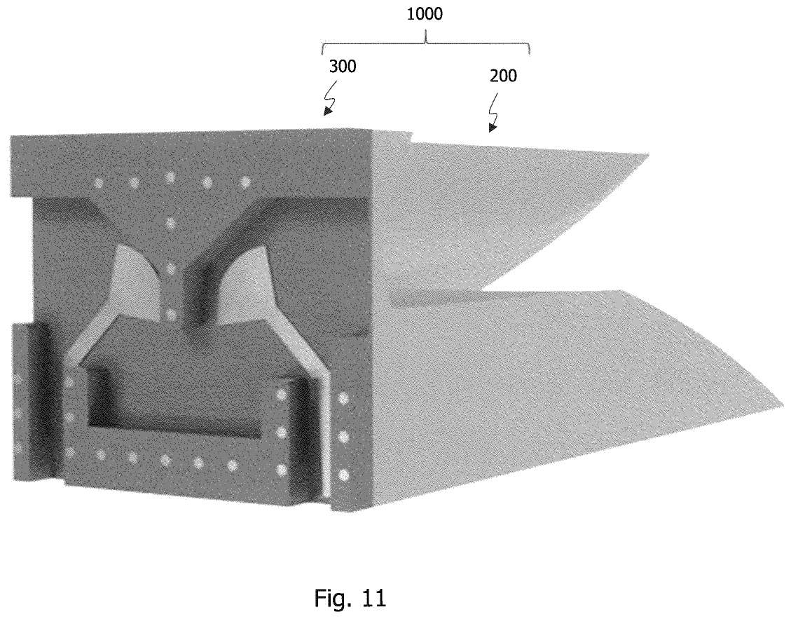

FIG. 11 shows a system 1000 according to the present disclosure. The system 1000 comprises the antenna array 100, 200 and the feeding unit 300. The feeding unit is arranged such that the ground plane 26 is parallel to a bottom surface of the antenna array 100, 200 and such that each of the striplines 22a, 22b extends across a different feed slot 16. Thus, when sending a feeding signal to one of the striplines 22, an electromagnetic wave will travel into the associated feed slot, be guided in the radiation direction by the antenna elements of the Vivaldi antenna, and finally emitted from the antenna array 100, 200 (e.g., towards a receiver such as a mobile user equipment).

Various modifications of the antenna array 100, 200, the feeding unit 300 and the system 1000 disclosed herein are possible. For example, the feeding unit 300 may be applied to other aperture antenna structures such as aperture coupled stacked patches or strongly coupled dipoles. The triangular lattice Vivaldi antenna array 100, 200 is not limited to be fed via the presented feeding unit 300, one may integrate a standard coaxial feeding or a variant of a Marchant BalUn feed instead. The presented solution may cover the frequency band from 6 to 15 GHz, but it can be extrapolated to any other operational frequency by scaling the geometry of the components.

The present disclosure generally provides for a solution in which dual-polarized fully-metallic Vivaldi antennas 10 (e.g., 10a-10f) are arranged in a triangular lattice with a suspended stripline feeding and matching network (e.g., the feeding unit 300). The solution may reduce the antenna element count of the antenna array compared to a square lattice. The proposed solution may reduce the number of Vivaldi antennas in the aperture of the antenna array up to a 15.5%. This may translate in a cost and complexity reduction of the overall antenna array and system.

The dual-polarized Vivaldi antenna array 10, 200 may provide an orthogonal polarization while opening the arms (e.g., the antenna elements) to a slant configuration, so the Vivaldi antennas 10 may be arranged in a triangular lattice. The feeding of the antenna array 100, 200 may be realized by asymmetric striplines that couple the feeding signals into the tapered slot (e.g., the feeding slot 16 such as the slots 16a-16h) of the Vivaldi antennas 10. In order to achieve such a coupling while maintaining the structural integrity of the array, a linearly tapered dogbone slot may be used.

The antenna array 100, 200 may be manufactured in a single piece by CNC milling or any other manufacturing technique such as electronic discharge machining (EDM) or additive manufacturing (AM).

The feeding unit 300 may be designed such that it is simple, cost-effective, low loss and can be easily integrated with a feeding network that delivers the signal to the antenna array with the correct phase and magnitude. The antenna array 100, 200 may be either milled or casted in one single piece (e.g., monocoque), with all the advantages that this brings. The integration with the feeding network may be easy, since it may not require any soldering joints but only require the antenna array 100, 200 to be placed on top of the feeding unit 300. That is, it may be sufficient to place the antenna array 100, 200 on top of the PCB of the feeding unit to assemble the system as a “readily-available” solution. Further advantages of the present disclosure may become apparent to those skilled in the art.

1. An antenna array comprising a plurality of Vivaldi antennas having a respective feed slot and defining a triangular lattice, the antenna array having a feeding side and a radiation side opposite to the feeding side, wherein at least one of the feed slots is open at the feeding side

2. The antenna array of claim 1, wherein the at least one feed slot is configured as a through-hole and/or bounded exclusively by surface portions that extend parallel to a same line.

3. The antenna array of claim 1, wherein the antenna array is configured to be void-free.

4. The antenna array of claim 1, wherein the at least one feed slot has a non-rectangular outline.

5. The antenna array of claim 1, wherein the at least one feed slot has a H-shaped, dumbbell-shaped or dog-bone-shaped outline.

6. The antenna array of claim 1, wherein the at least one feed slot is bounded by at least two opposing parallel planar surface portions.

7. The antenna array of claim 6, wherein the at least one feed slot comprises:
a feed volume between two of the opposing parallel planar surface portions; and
at least one resonance cavity adjacent to the feed volume.

8. The antenna array of claim 7, wherein the at least one resonance cavity transitions, at the radiation side into a widening portion.

9. The antenna array of claim 8, wherein the feed volume transitions, at the radiation side into a radiating portion of the respective Vivaldi antenna, the radiating portion widening differently than the widening portion.

10. The antenna array of claim 1, wherein the antenna array is configured to be fed with a stripline or a microstrip when the stripline or microstrip is arranged adjacent to the feed slot of one of the Vivaldi antennas on the feeding side.

11. The antenna array of claim 1, wherein the feed slots of a first subset of the Vivaldi antennas are aligned into a first direction and the feed slots of a second subset of the Vivaldi antennas are aligned into a second direction that differs from the first direction.

12. An antenna system comprising:
an antenna array comprising a plurality of Vivaldi antennas having a respective feed slot and defining a triangular lattice, the antenna array having a feeding side and a radiation side opposite to the feeding side, wherein at least one of the feed slots is open at the feeding side; and
a feeding unit comprising a plurality of feeding elements arranged such that, when the feeding unit is arranged in a predefined pose relative to the antenna array, electromagnetic signals can be fed via the plurality of feeding elements into at least one of the plurality of Vivaldi antennas of the antenna array to cause the at least one Vivaldi antenna to emit radio waves.

13. The antenna system of claim 12, wherein the plurality of feeding elements are arranged in a same plane.

14. The antenna system of claim 13, wherein the antenna array has a first outer surface on the feeding side wherein the at least one feed slot is open at the first outer surface and the feeding unit has a second outer surface configured to be aligned in parallel with the first outer surface when the feeding unit is arranged in the predefined pose relative to the antenna array.

15. The antenna system of claim 12, comprising one or more alignment elements configured to align the feeding unit in the predefined pose relative to the antenna array.

16. The antenna system of claim 12, wherein each of two or more of the plurality of feeding elements is associated with a different one of the feed slots of the Vivaldi antennas.

17. The antenna system of claim 16, wherein at least one of the plurality of feeding elements is configured to, when the feeding unit is arranged in the predefined pose relative to the antenna array extend across the feed slot of the associated Vivaldi antenna.

18. The antenna system of claim 12, wherein at least one of the plurality of feeding elements comprises a stripline and/or a microstrip.

19. The antenna system of claim 18, wherein the stripline is configured as an asymmetric suspended stripline.

20. The antenna system of claim 12, wherein a first subset of the plurality of feeding elements are electrically coupled together into a first group and a second subset of the plurality of feeding elements are electrically coupled together into a second group, wherein the first subset differs from the second subset.
